(19) United States
(12) Patent Application Publication
(10) Pub. No.: US 2008/0314398 A1
(43) Pub. Date: Dec. 25, 2008

(54) Method of Printing Smoking Article Wrapper

(75) Inventor: Mark Fish, Nottingham (GB)

Correspondence Address: HOVEY WILLIAMS LLP, 10801 Mastin Blvd., Suite 1000, Overland Park, KS, 66210, US

(73) Assignee: IMPERIAL TOBACCO LTD., Bristol (UK)

(21) Appl. No.: 11/575,434

(22) PCT Filed: Sep. 1, 2005
(86) PCT No.: PCT/EP2005/009436

§ 371 Date: Apr. 28, 2008

(30) Foreign Application Priority Data
Sep. 16, 2004 (EP) 04022071.7

(51) Int. Cl. A24D 1/02; B41F 9/00; A24C 5/38

(52) U.S. Cl. 131/284; 101/152; 131/365

(57) ABSTRACT

In a method of printing smoking article wrapper in a smoking article making machine, preferably a smoking article rod making machine (1), during the manufacture of smoking articles, the printing technique applied is gravure printing. Preferably, in the printing apparatus (6), a printing agent is supplied onto a gravure printing cylinder (10) via a pressurized chamber (14) which contacts the printing cylinder (10) through a seal. The printing agent can be pumped through the pressurized chamber (14).

The invention relates to a method of printing smoking article wrapper in a smoking article making machine during the manufacture of smoking articles as well as a smoking article wrapper printing apparatus and a smoking article comprising a wrapper which is printed according to the method.

Generally, the wrappers of smoking articles, e.g. the cigarette paper of a cigarette, are provided with prints, e.g. a symbol, figures or the trademark of the cigarette in question.

Gravure printing is a widely used method for printing, e.g. magazines, and allows for the printing of half-tones or photographs in a high quality. In gravure printing, printing ink is applied to a printing cylinder provided with a pattern of depressions representing the text or images to be printed and is transferred to the paper to be printed. Typical gravure printing machines have a speed of 200 m/min to 400 m/min. Such high-speed printing presses use 1 m to 2 m wide printing substrates, e.g. paper webs or sheets.

Smoking article wrapper could be cut from pre-printed paper webs prepared by means of a gravure printing technique and stored in the form of rolls, as used in commercial smoking article rod making machines. In such machines, the wrapper is supplied from the storage roll and longitudinally wrapped around a continuously formed tobacco rod. Thereafter, the wrapped rod is cut into individual pieces. When pre-printed wrapper is used, however, it is very hard to cut the rod in register with the print on the wrapper, i.e. at the correct positions such that the prints are properly located on the finished smoking article.

To avoid this problem, cigarette industry prefers to print the smoking article wrapper in a smoking article rod making machine during the manufacture of smoking article rods, i.e. to print “on-line”. Since the processing speed of a smoking article rod making machine is large, usually larger than 400 m/min, the printing technique used for that purpose is letter press printing or flexography, in which a raised stamp is inked by means of rollers and pressed against the paper to be printed. Such methods are disclosed in WO 2003/000497 A2, EP 1 125 737 A2, WO 1999/51439 A1, DE 196 48 567 A1, or GB 2 100 192 B.

Whereas these online letter press or flexography techniques allow for a more or less precise alignment of the figures or symbols to be printed onto the wrapper, the printing quality is relatively poor. Half-tone images cannot be reproduced properly, and it is not possible to print evenly on larger areas. Moreover, the letter press stamp tends to get dirty relatively quickly, while the cleaning procedure is a lengthy job, involving the disassemblage of the printing device, which usually takes two to three hours.

It is the object of the invention to provide a possibility of printing smoking article wrapper with a high quality and in a cost-effective manner.

This problem is solved by the method of printing smoking article wrapper according to claim 1 and by the smoking article wrapper printing apparatus according to claim 16. Claim 24 relates to a smoking article comprising a wrapper which is printed according to the claimed method. Advantageous versions of the invention follow from the dependent claims.

In the method according to the invention, smoking article wrapper is printed in a smoking article making machine during the manufacture of smoking articles, preferably in a smoking article rod making machine during the manufacture of smoking article rods. The printing technique applied is gravure printing.

Gravure printing allows for a much higher level of printing quality. For example, it is possible to print large block areas of colour uniformly, or half-tone images can be reproduced properly, in contrast to conventional letter press or flexography printing. Since the gravure printing technology is used on-line in the smoking article rod making machine, there are no problems with respect to misaligned printed objects which would occur with pre-printed wrappers. In the invention, the printing speed can be much larger than that of commercial gravure printing machines (200 m/min to 400 m/min). In order to adapt the printing process to the operating speed of a fast smoking article rod making machine, with the method according to the invention a printing speed of, e.g., 720 m/min is possible.

Preferably, the smoking article wrapper is supplied from a storage roll, is fed through a system of guide rollers and tension rollers to the printing cylinder, and, after printing, is longitudinally wrapped around the rod processed by the smoking article rod making machine. The wrapped rod is cut into individual smoking article rod pieces in register with the printing process. In subsequent steps, these pieces can be provided with filters, etc. The method can be run in a conventional smoking article rod making machine, e.g. a conventional cigarette machine. Usually the wrapper supplied from the storage roll has a width in the order of a few cm, e.g. 26.75 mm, the circumference of a typical cigarette plus the width of the gluing seam of the wrapper. Thus, the gravure printing technique is applied to a narrow printing substrate, in contrast to 1 m to 2 m wide printing substrates used in typical high-speed gravure printing presses.

In an advantageous versions of the invention, a printing agent, e.g. printing ink, is supplied onto a gravure printing cylinder via a pressurized chamber which contacts the printing cylinder through a seal, e.g. a sliding seal. Preferably, the printing agent is pumped through the pressurized chamber, e.g. continuously pumped. This design is very compact, works very reliable, and does not tend to get dirty. In particular, in a separate cleaning cycle, a cleaning fluid can be pumped through the chamber in order to remove any dirt inside the chamber and on the surface of the printing cylinder. This cleaning procedure is very fast and takes, e.g., 7 minutes, which is much shorter than the time required for cleaning a conventional letter press apparatus.

In the method according to the invention, it is possible to use more than one gravure printing cylinder, wherein different printing agents are assigned to different printing cylinders. For example, three gravure printing cylinders can be used for three-colour printing. In this case, three images, each one in a different base colour, can be printed at the same location of the smoking article wrapper, resulting in a true-colour image. Moreover, four or multiple printing cylinders can be used advantageously for printing colours plus different printing agents.

The preferred printing ink is a water-soluble printing ink. Water-based dye ink systems are available in food grade quality and are approved. It is also conceivable to use a high-lustre metal, e.g. gold, ink system.

The printing agent is not restricted to be a printing ink, however. The method according to the invention can also be applied to quite different kinds of printing agents, e.g. to stiffening agents or to burn modifiers (preferably burn retardants) or to flavourings. In principle, such ingredients could be added to the wrapper during or after the production of the wrapper material. An on-line printing technique, however, has the large advantage that the agent can be applied in a certain pattern or at certain locations such that, e.g., a burn retardant acts after the cigarette has been smoked down to a pre-selected length or a flavouring is released during a pre-selected phase of smoking a cigarette. Burn retardants are disclosed, e.g., in U.S. Pat. No. 4,619,278 A, U.S. Pat. No. 4,452,259 A, U.S. Pat. No. 4,622,983 A, EP 0 671 505 B1, EP 1 123 665 A2, WO 2001/078471 or EP 0 325 920 and, generally, are well known in the art.

The term “smoking article wrapper” is to be understood in a broad sense. A typical example is cigarette paper, when the smoking article rod making machine is a cigarette machine. Another example is a tobacco roll wrapper, which is unsmokeable. In this case, the smoking article rod making machine is used to make tobacco rolls having a tobacco rod surrounded by an unsmokeable tobacco roll wrapper. This product cannot be smoked like a cigarette, but its tobacco content has to be transferred from the tobacco roll wrapper into a smokeable cigarette wrapper or a prefabricated cigarette sleeve. Other examples of related smoking articles are a cigar having a wrapper and/or binder, a cigarillo having a wrapper and/or binder, a cigarette paper tube or a portioned fine-cut tobacco unit, but also a cigarette filter tube, etc.

It is also possible to apply the method according to the invention in a smoking article paper making machine during the manufacture of individual smoking article papers, preferably in a machine for making paper booklets comprising rolling papers. Such rolling papers are used by consumers who make (“roll”) their cigarettes from a supply of tobacco and individual rolling papers provided in a booklet containing folded and interleaved rolling paper sheets. A machine for making such paper booklets is disclosed, e.g., in EP 0 165 747 B1. It is advantageous when the rolling papers are printed by the method according to the invention right before they are folded into a bundle and packed into a paper booklet.

The object printed in the gravure printing process is not limited to simple forms as text or stamp-like figures, but can include all kinds of images, photographic images, figures, diagrams, and so on. Regular patterns are conceivable as well, for example in an ornamental design or for technical reasons (e.g. with respect to the desired locations of a stiffening agent, a burn retardant, or a flavouring agent applied by the printing technique).

The smoking article wrapper printing apparatus according to the invention is used in a smoking article rod making machine during the manufacture of smoking article rods, and it is a gravure printing device. Generally, an existing commercial smoking article rod making machine can be equipped with such printing apparatus, without major modifications. It is also possible to use the smoking article wrapper printing apparatus in a smoking article paper making machine during the manufacture of individual smoking article papers.

Preferred versions of the apparatus have already been presented above in the discussion of the method according to the invention. In particular, when the apparatus comprises a pressurized chamber contacting a gravure printing cylinder through a sliding seal, a cleaning fluid can be pumped through the pressurized chamber in a separate cleaning cycle. The locations of printing on the smoking article wrapper in register with the operation of the smoking article rod making machine, in particular in register with its cutting devices, can be controlled by a control device included in the printing apparatus.

In the following, the invention is described in more detail by means of embodiments. The drawings show in

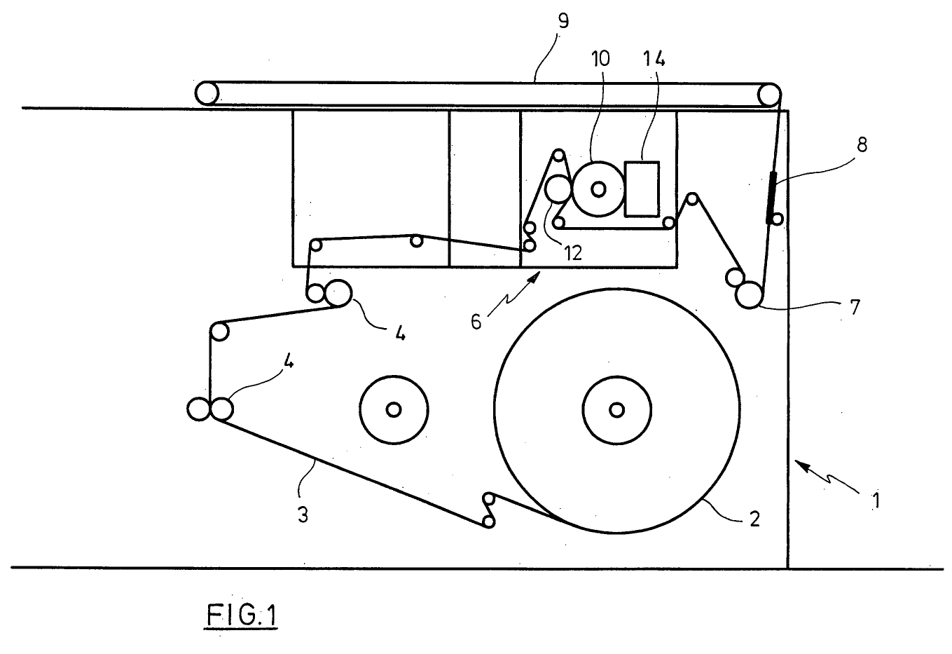

FIG. 1 a schematic view of a printing apparatus according to the invention, used for one-colour printing in a smoking article rod making machine, and

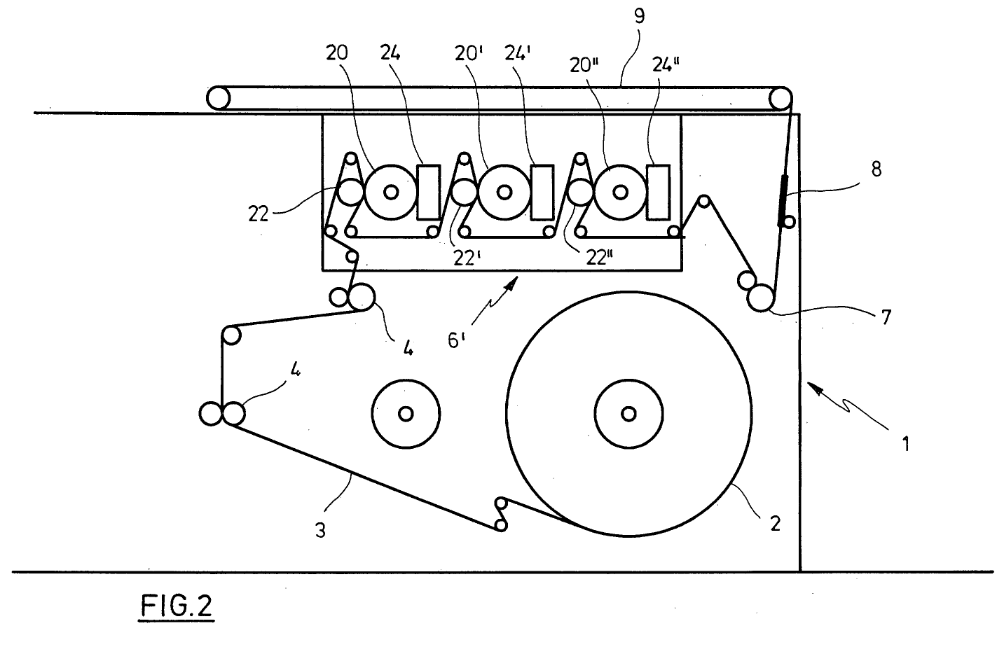

FIG. 2 a schematic view of another embodiment of a printing apparatus according to the invention, used for three-colour printing in a smoking article rod making machine.

FIG. 1 is a schematic representation of the area of a smoking article rod making machine 1 in which smoking article wrapper is printed and wrapped around the rod processed by the smoking article rod making machine 1. In the embodiment, the smoking article rod making machine 1 is a conventional cigarette machine preparing cigarette rods, but in order to print text or figures onto the smoking article wrapper (i.e. the cigarette wrapper), a different printing apparatus is used instead of a conventional letter press or flexography unit.

Smoking article wrapper (in the embodiment cigarette paper having a width of 26.75 mm) is supplied from a storage roll 2. The unrolled wrapper, which is designated by reference numeral 3, is fed through a system of guide rollers and tension rollers 4 to a printing apparatus 6, which will be described in more detail below. After having been printed and leaving the printing apparatus 6, the wrapper 3 passes the additional rollers 7 and runs through a guide 8, whereupon it enters a conveyor 9.

On conveyor 9, the wrapper 3 meets the tobacco rod processed by machine 1 and is longitudinally wrapped around the rod, as known in the art. Afterwards, the wrapped rod is cut into individual smoking article rod pieces, which can be further processed (e.g. equipped with filters, etc.).

In the embodiment, guide 8 includes a control device which detects the positions of the text and figures on the (still) endless wrapper 3 in order to control the cutter which cuts the rod into individual smoking article rod pieces. In this way, it is ensured that the text or figures on the wrappers of the finished cigarettes are at the correct positions.

The printing apparatus 6 is different from a conventional letter press or flexography unit. It comprises a gravure printing cylinder 10, a counter-pressure cylinder 12 and a chamber 14. Additional components are guide and tension rollers, drives, etc. which, in general, are familiar to the person skilled in the art and need not be explained in detail.

The printing cylinder 10 is a gravure printing cylinder manufactured as known in the art of gravure printing. It is inked by means of chamber 14, see below. When the wrapper 3 travels between printing cylinder 10 and counter-pressure cylinder 12, the image, text, etc. provided on printing cylinder 10 is printed onto the wrapper 3.

In the area facing printing cylinder 10, chamber 14 has an opening which is sealed against printing cylinder 10 by means of a sliding seal attached to the edge of the opening. Furthermore, chamber 14 has an inlet and an outlet (not shown in FIG. 1) connecting chamber 14, via tubes, to a supply of printing ink. Chamber 14, the supply of printing ink, the tubes mentioned and a pump form a closed circuit which is pressurized by means of the pump. Thus, the printing ink circulates through the circuit and is transferred to printing cylinder 10 via chamber 14. Part of the sliding seal of chamber 14 cleans the surface of printing cylinder 10 (except for its depressions which are to be inked) in order to prevent excess ink from being transferred to wrapper 3.

In the embodiment, the pressure and temperature of chamber 14 and the inking circuit are monitored via sensors.

Printing apparatus 6 can be easily cleaned when chamber 14 is disconnected from the ink supply and is connected to a cleaning fluid supply and when the cleaning fluid is pumped through chamber 14, while printing cylinder 10 rotates. This does not require disassemblage of the printing apparatus 6 and, consequently, saves much time and costs.

In one example, printing apparatus 6 was operated in a cigarette machine 1 at a speed of up to 730 m/min in order to print large surface area cigarette logos. This style of logo would normally give very poor print quality using rotary letter press due to ink starvation at the die surface, resulting in a patchy image having missing portions of the printed area. Printing apparatus 6, however, produces a very clean, sharp and solid print at all speeds up to the tested maximum speed of 730 m/min.

In another example, at speeds up to 730 m/min, very fine art work including half-tone images was printed in registration with the cutter head of cigarette machine 1. Some of these designs covered virtually the whole length of the finished cigarette. In another example, photographic images were printed in the same range of speeds. With a conventional rotary letter press system, it would be impossible to achieve such results.

In the embodiment described above, the printing agent supplied via chamber 14 is a printing ink. In another example, flavourings at a range of viscosities can be printed directly onto wrapper 3, e.g. the cigarette paper, just prior to cigarette manufacture. As the cigarettes are packaged shortly thereafter, the flavourings can be preserved. Moreover, it is possible to print the flavourings to the cigarette paper in any desired pattern, e.g. in order to release a certain flavouring at a desired moment in the smoking process of the cigarette.

In another example, burn modifiers at a range of viscosities can be printed directly onto the cigarette paper, just prior to cigarette manufacture.

FIG. 2 shows another embodiment of a smoking article wrapper printing apparatus used in a smoking article rod making machine. Since the embodiments of FIGS. 1 and 2 are similar, in both Figures the same reference numerals are used for components corresponding to each other.

In FIG. 2, however, the printing apparatus (designated by 6′) allows for three-colour printing. To this end, it comprises three units, one for each basis colour, which include gravure printing cylinders 20, 20′ and 20″, corresponding counter-pressure cylinders 22, 22′ and 22″ as well as corresponding chambers 24, 24′ and 24″, respectively. Each unit works as described before with respect to the embodiment according to FIG. 1.

It is also conceivable to combine printing units processing printing ink and printing units processing other printing agents, like stiffening agents (e.g. starch), burn retardants, flavourings and/or flavour precursors.

A large advantage of printing the flavours or other agents during or at the end of the smoking article making process is that less or no losses of flavours or agents occur. For example, in using the method according to the invention in order to apply flavours, instead of flavouring the tobacco in conventional flavouring drums, complex cleaning steps can be avoided, in particular when flavour batches are changed.

1. A method of printing a smoking article wrapper, the method comprising the steps of:
printing the smoking article wrapper in a smoking article making machine during the manufacture of smoking articles using the gravure printing technique.

2. The method as claimed in claim 1,
said smoking articles comprising smoking article rods.

3. The method as claimed in claim 2;
supplying the smoking article wrapper from a storage roll;
feeding the smoking article wrapper through a system of guide rollers and tension rollers to at least one printing cylinder;
after printing, longitudinally wrapping the smoking article wrapper around the rod processed by the smoking article rod making machine; and
cutting the wrapped rod into individual smoking article rod pieces in register with the printing process.

4. The method as claimed in claim 2,
wherein the smoking article wrapper is selected from the group consisting of cigarette paper, cigar wrapper, cigarillo wrapper, fine-cut tobacco unit wrapper, unsmokeable tobacco roll wrapper, and cigarette filter tube wrapper.

5. The method as claimed in claim 1,
wherein the smoking article making machine comprises a smoking article paper making machine including a machine for making paper booklets comprising rolling papers, with the papers defining the smoking article wrapper.

6. The method as claimed in claim 1,
said printing step including the step of supplying a printing agent onto a gravure printing cylinder via a pressurized chamber which contacts the printing cylinder through a seal.

7. The method as claimed in claim 6,
said printing step including the step of pumping the printing agent through the pressurized chamber.

8. The method as claimed in claim 1,
said printing step including the step of using at least two different gravure printing cylinders, wherein different printing agents are assigned to different printing cylinders.

9. The method as claimed in claim 8,
wherein three gravure printing cylinders are used for three-colour printing.

10. The method as claimed in claim 1,
wherein the printing agent is a printing ink.

11. The method as claimed in claim 1,
wherein the printing agent is a stiffening agent.

12. The method as claimed in claim 1,
wherein the printing agent is a burn modifier.

13. The method as claimed in claim 1,
wherein the printing agent is a flavouring.

14. The method as claimed in claim 1,
wherein the object printed in the printing process is selected from the group consisting of images, photographic images, figures, text, diagrams, patterns, and combinations thereof.

15. The method as claimed in claim 1,
wherein the printing speed is larger than 400 m/min.

16. A smoking article rod making apparatus for manufacturing printed smoking article rods, wherein each smoking article rod includes a smoking article wrapper, the apparatus comprising:
a mechanism for manufacturing smoking article rods; and
a gravure printing device operably coupled with the mechanism to print on the smoking article wrapper and supply the printed smoking article wrapper during the manufacture of the smoking article rods.

17. The apparatus as claimed in claim 16,
said gravure printing device including a gravure printing cylinder;
a pressurized chamber that presents an opening; and
a seal coupled to the opening, with the seal contacting the gravure printing cylinder,
said pressurized chamber being configured to contain a printing agent to be supplied through the opening and onto the printing cylinder.

18. The apparatus as claimed in claim 17,
said pressurized chamber configured to have the printing agent pumped therethrough.

19. The apparatus as claimed in claim 18,
said printing device being configured to being cleaned in a separate cleaning cycle by pumping a cleaning fluid through the pressurized chamber.

20. The apparatus as claimed in claim 16; and
a control device adapted to control the locations of printing on the smoking article wrapper in register with the operation of the smoking article rod making machine.

21. The apparatus as claimed in claim 16,
said gravure printing device including at least two different gravure printing cylinders, wherein different printing agents are assignable to different printing cylinders.

22. The apparatus as claimed in claim 21,
said gravure printing device including three gravure printing cylinders for three-colour printing.

23. The apparatus as claimed in claim 16,
wherein the apparatus is configured to operate at a printing speed which is larger than 400 m/min.

24. A smoking article comprising a smoking article wrapper and gravure-printed agent that forms an image on the wrapper, with the image being printed according to the method of claim 1.

25. The smoking article as claimed in claim 24,
said smoking article being selected from the group consisting of a cigarette having a cigarette paper; a cigar having a cigar wrapper, a cigar binder, or both the cigar wrapper and the cigar binder; a cigarillo having a cigarillo wrapper, a cigarillo binder, or both the cigarillo wrapper and the cigarillo binder; a cigarette paper tube; a portioned fine-cut tobacco unit; and a cigarette filter tube.

26. The smoking article as claimed in claim 24,
said smoking article comprising a tobacco roll having tobacco and an unsmokeable tobacco roll wrapper, with the tobacco roll being provided for transferring the tobacco from the tobacco roll wrapper into a smokeable cigarette wrapper or prefabricated cigarette sleeve.

27. The smoking article as claimed in claim 24,
said smoking article comprising rolling paper.

28. The method as claimed in claim 6,
said printing step including the step of continuously pumping the printing agent through the pressurized chamber.

29. The method as claimed in claim 1,
wherein the printing agent is a water-soluble printing ink.

30. The method as claimed in claim 1,
wherein the printing agent is a burn retardant.

31. The smoking article as claimed in claim 24,
said image comprising a half-tone image.
